(19) United States
(12) Patent Application Publication
(10) Pub. No.: US 2012/0012409 A1
(43) Pub. Date: Jan. 19, 2012

(54) Power-Assist Hand Truck or Platform Cart

(76) Inventors: Patrick Edward Turner, Rogers, AR (US); Jebediah Eugene Turner, Bentonville, AR (US)

(21) Appl. No.: 13/175,985

(22) Filed: Jul. 5, 2011

Related U.S. Application Data
(60) Provisional application No. 61/364,810, filed on Jul. 16, 2010.

(51) Int. Cl. B60K 1/00

(52) U.S. Cl. 180/65.31

(57) ABSTRACT

A power-assist hand truck for assisting in the movement of objects. The powered hand truck includes two electric disc gearmotors, an overrunning clutch hub for each driven wheel, an e-stop switch, a speed control, a power source, a motor controller, and other necessary electronics, which can be integrated into an existing hand truck or platform cart or compose a new handtruck or platform cart. Power is provided by replaceable/rechargeable batteries. The batteries can be charged from a stationary power source or by a mobile power source such as that of a vehicle battery. In forward motion the speed control and motor controller provide variable power-assist levels, however, the overrunning clutch hubs allow the user to walk as quickly as desired. The e-stop switch engages and disengages the gearmotors from the power supply, thereby allowing the user to selectively switch between regenerative braking and low rolling resistance operation.

### CROSS-REFERENCE TO RELATED APPLICATIONS

This application claims the benefit of PPA Application Ser. No. 61/364,810, filed Jul. 16, 2010 by the present inventors, which is incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND—PRIOR ART

The common 2-wheel manual hand truck as shown in FIG. 1A and FIG. 1B has been used for decades to assist in the movement of heavy and bulky objects. Some hand trucks, referred to as convertible and as shown in FIG. 2A, FIG. 2B, and FIG. 3, were developed to be converted into a 4-wheel platform mode. In platform mode the hand truck functions as a platform cart.

Convertible hand trucks are commonly used by delivery drivers to allow them to transport heavier and bulkier items than they could with a 2-wheel hand truck, while still having the option to transport small loads on 2-wheels and to be stored in the smaller 2-wheel profile. In some cases these delivery drivers repetitively push and pull loads in excess of 600 lbs over long distances. Driver fatigue decreases efficiency and increases the possibility of injury.

According to the 2009 Liberty Mutual Workplace Safety Index (WSI), overexertion was the number one cause of workplace disabling injuries in 2007. Injuries from overexertion encompassing excessive lifting, pushing, pulling, holding, carrying, and throwing cost U.S. companies over $12.7 Billion in 2007.

In order to address this problem several powered convertible hand trucks have been developed and marketed specifically to the delivery industry. Examples include the “Powered Gemini” by Magliner Inc., the CobraPro by Wesco Industrial Product Inc., and the “Powered Hand Truck” shown in U.S. Pat. No. 7,163,212 invented by Steven J. Chambers and sold by Industry Assist Inc. The Gemini and Wesco hand trucks are sold fully assembled, whereas the Industry Assist unit can be purchased as a retrofit kit for an existing hand truck or as a complete hand truck.

Although these powered hand trucks would logically seem to be useful in reducing operator fatigue none of them has been widely adopted by the industry. We were able to identify and understand the needs of the delivery drivers, which is key to understanding the disadvantages of the prior art powered hand trucks. The most important aspects of any powered hand truck to the delivery drivers are that it help move a heavy load, that it be lightweight, and that it allow them to work at their traditional work pace. All three of the aforementioned prior art powered hand trucks share the same fundamental disadvantages to the delivery drivers as outlined below.

Manual hand trucks weigh around 45 lbs and delivery drivers normally lift them into and out of their trucks by hand. For safety, most delivery drivers working for companies such as FedEx and UPS are limited to lifting around 70 lbs. The weight of the prior art powered convertible hand trucks exceeds 110 lbs. The excessive weight of the hand trucks requires a truck lift or ramp to load and unload them, both of which slow the operators down as compared to their traditional work pace.

Maximum operating speed is another disadvantage of all prior art powered hand trucks. The maximum operating speed of the prior art powered hand trucks is around 4 mph. However, many delivery drivers often exceed 5 mph with their traditional manual hand trucks. Over long distances this speed restriction slows the operator down.

The prior art powered hand trucks also present several disadvantages to delivery drivers in cases of failure during a delivery. First, the excessive weight of these powered hand trucks makes them more difficult to push, pull and maneuver than a manual hand truck would be. Second, the replacement of the exposed axle on a manual hand truck with a bulky transaxle reduces the operators' ability to brace the hand truck with his foot during initial load balancing in 2-wheel mode.

### BRIEF SUMMARY OF THE INVENTION

In accordance with one embodiment a power-assist hand truck comprises a convertible hand truck frame, right and left wheels each driven by a disc style gearmotor, an overrunning clutch for each driven wheel, a motor controller, a variable speed throttle, and a plurality of batteries.

### ADVANTAGES

Accordingly, several advantages of one or more aspects are to provide a power-assist hand truck or platform cart that is lighter weight, has a faster maximum speed, and allows the operator to work at his or her traditional work pace. These and other advantages of one or more aspects will become apparent from a consideration of the ensuring description and accompanying drawings.

### BRIEF DESCRIPTION OF THE SEVERAL VIEWS OF THE DRAWING

Corresponding reference characters indicate corresponding components throughout the several views of the drawings.

FIG. 1A is a side view of a prior art hand truck.

FIG. 1B is a front view of the prior art hand truck.

FIG. 2A is a side view of a prior art convertible hand truck.

FIG. 2B is a front view of the prior art convertible hand truck.

FIG. 3 is a side view of the prior art convertible hand truck in a platform (i.e. four-wheel) mode.

FIG. 4A is a side view of a power-assist hand truck according to the present invention.

FIG. 4B is a front view of the power-assist hand truck according to the present invention.

FIG. 5 is a side view of the power-assist hand truck or platform cart according to the present invention in a platform mode.

FIG. 6A is a side view of the control handle attached to the convertible frame including handgrips and a grip mountable speed control according to the present invention.

FIG. 6B is a front view of the control handle attached to the convertible frame including handgrips and a grip mountable speed control according to the present invention.

FIG. 7A is a top view of the grip mountable speed control according to the present invention.

FIG. 7B is a side view of the grip mountable speed control according to the present invention.

FIG. 7C is an end view of the grip mountable speed control according to the present invention.

FIG. 8A is a side view of the lower third of the convertible hand truck according to the present invention, which includes the gearmotors, batteries, controller, side plates, and right skid rail. Both wheels, the left side grease cover used to cover the hub gear and mating gear, and the left skid rail are not shown.

FIG. 8B is a front view of the lower third of the convertible hand truck according to the present invention, which includes the gearmotors, batteries, controller, side plates, and right skid rail. Both wheels, the left side grease cover used to cover the hub gear and mating gear, and the left skid rails are not shown.

FIG. 9A is a side view with respect to the power-assist hand truck of an overrunning clutch hub used to engage and disengage the wheel from the drivetrain according to the present invention.

FIG. 9B is a front view with respect to the power-assist hand truck of an overrunning clutch hub used to engage and disengage the wheel from the drivetrain according to the present invention.

FIG. 10A is a wheel (outside) side view of a side plate and gearmotor according to the present invention.

FIG. 10B is a bottom view of a side plate and gearmotor according to the present invention.

FIG. 10C is an axle (inside) side view of a side plate and gearmotor according to the present invention.

FIG. 11A is a front view of the controller and batteries according to the present invention.

FIG. 11B is a side view of the controller and batteries according to the present invention.

FIG. 11C is a back view of the controller and batteries according to the present invention.

FIG. 12A is a front view with respect to the power-assist hand truck of a grease cover used to cover the hub gear and mating gear.

FIG. 12B is a side view with respect to the power-assist hand truck of a grease cover used to cover the hub gear and mating gear.

### DETAILED DESCRIPTION OF THE INVENTION

The following description is of the best mode presently contemplated for carrying out the invention. The description is not to be taken in a limiting sense, but is made merely for the purpose of describing one or more preferred embodiments of the invention.

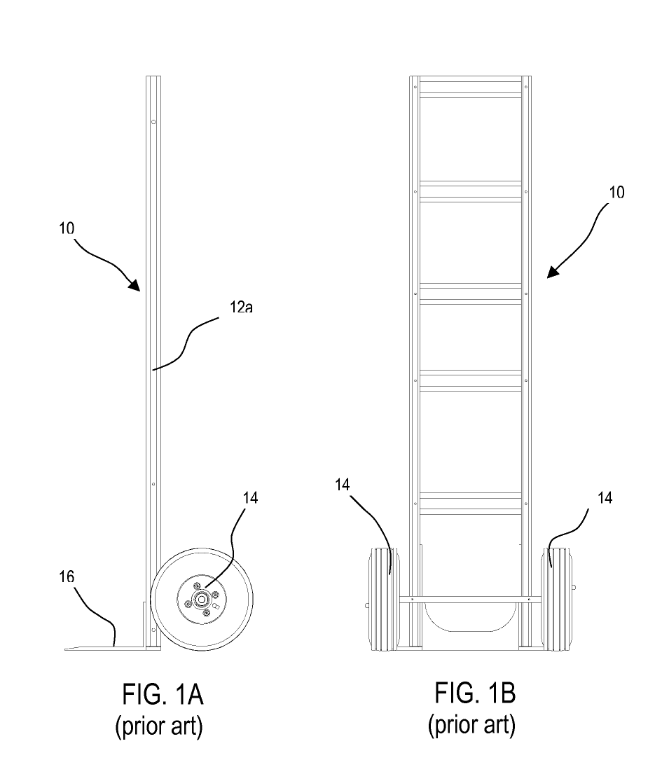

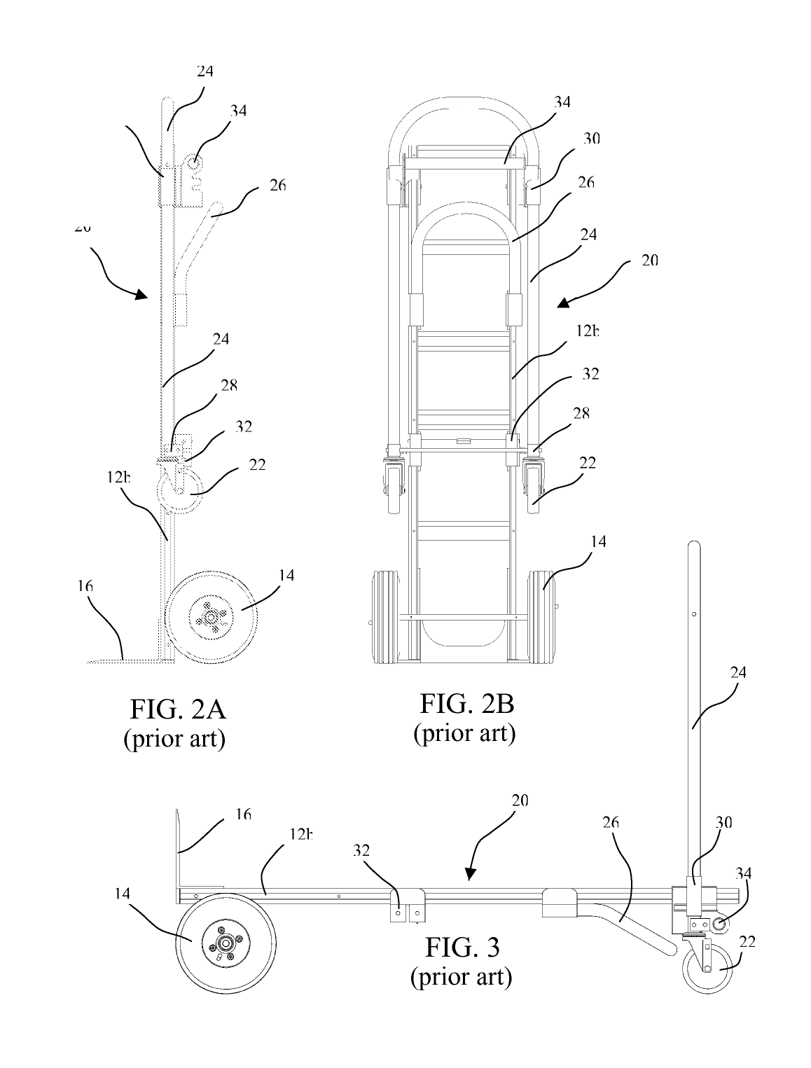

An example of prior art hand truck hand truck 10 is shown in side view in FIG. 1A, and in front view in FIG. 1B. Such hand truck comprises a first frame 12a, hand truck wheels 14, and a nose 16. Such hand truck 10 is useful for moving objects, which may be balanced on the nose 16. An example of a prior art convertible hand truck 20 is shown in side view in FIG. 2A, and in front view in FIG. 2B, and is further shown in FIG. 3 converted from a hand truck to a platform. The convertible hand truck 20 comprises a second frame 12b, the hand truck wheels 14, the nose 16, and additionally, caster wheels 22 supported by a convertible frame 24, second frame handle 26 mounted on second frame 12b, convertible frame handle 34 mounted on second frame 12b, a latching member 28 attached to the convertible frame 24 proximal to the caster wheels 22, pivot/slide member 30 slideably cooperating with convertible frame 24, and a latch receiving member 32 attached to the second frame 12b and adapted to cooperate with the latching member 28.

The convertible hand truck 20 may be configured as a standard hand truck as seen in FIGS. 2A and 2B by substantially aligning the convertible frame 24 with the second frame 12b and latching the latching member 28 with the latching receiving member 32. The convertible hand truck 20 may be converted to a four-wheel hand truck (or platform mode) by unlatching the latching member 28 from the latch receiving member 32, rotating the convertible frame 24 at the pivot/slide member 30 to be substantially perpendicular to the second frame 12b, and sliding the convertible in the pivot/slide member 30, as seen in FIG. 3.

Prior art convertible hand truck 20 as shown in FIGS. 2A, 2B, and 3 is sold by several companies and commonly used, especially in the truck delivery industry. These convertible hand trucks 20 are typically specified as being able to carry over 1,000 lbs in platform mode as seen in FIG. 3 and are typically around twenty-one inches in overall width and have frame widths of around twelve inches.

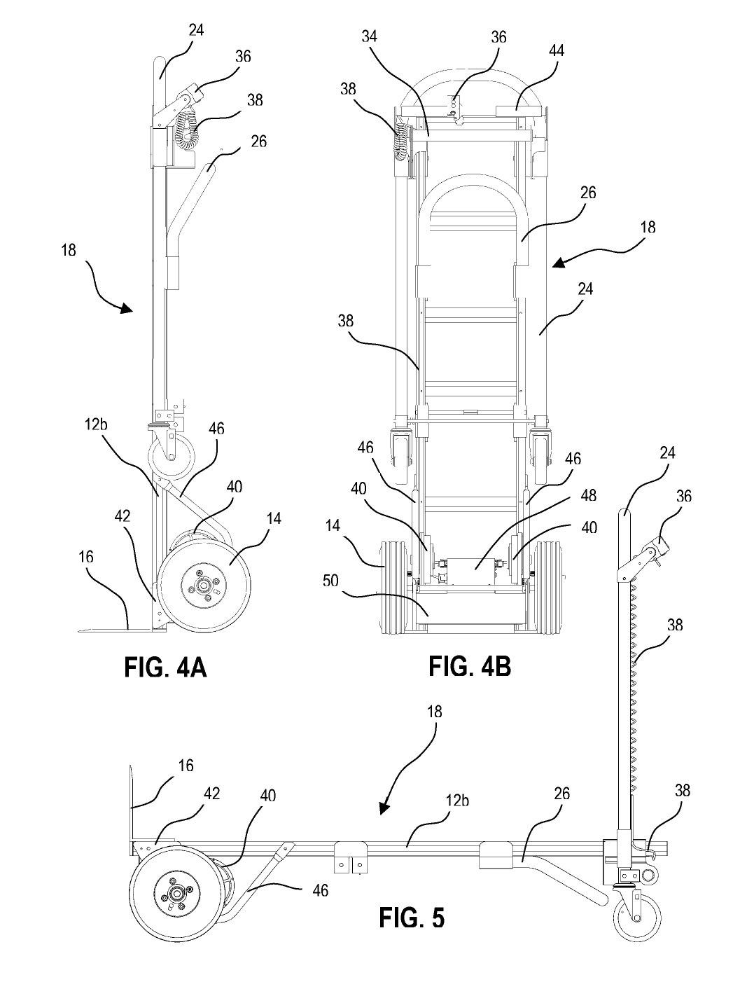

The present invention consists of a power-assist hand truck 18 shown in side view in FIG. 4A, in front view in FIG. 4B, and in platform mode in FIG. 5. FIG. 5 also represents a platform cart.

The power-assist hand truck consists of a convertible hand truck 20 frame, gearmotors 40, controller 48, and cooperating components. The different and additional components that comprise the power-assist hand truck 18 when compared to the prior art hand trucks 10 and 20 could be used to convert a used prior art hand truck, a new prior art hand truck, or incorporated in the initial manufacturing of a hand truck.

The gearmotors 40 are preferably positioned immediately above and in proximity to the second frame 12b as shown in FIG. 4B thereby leaving the axle 61 mostly exposed in similarity to prior art hand truck 10 and prior art convertible hand truck 20.

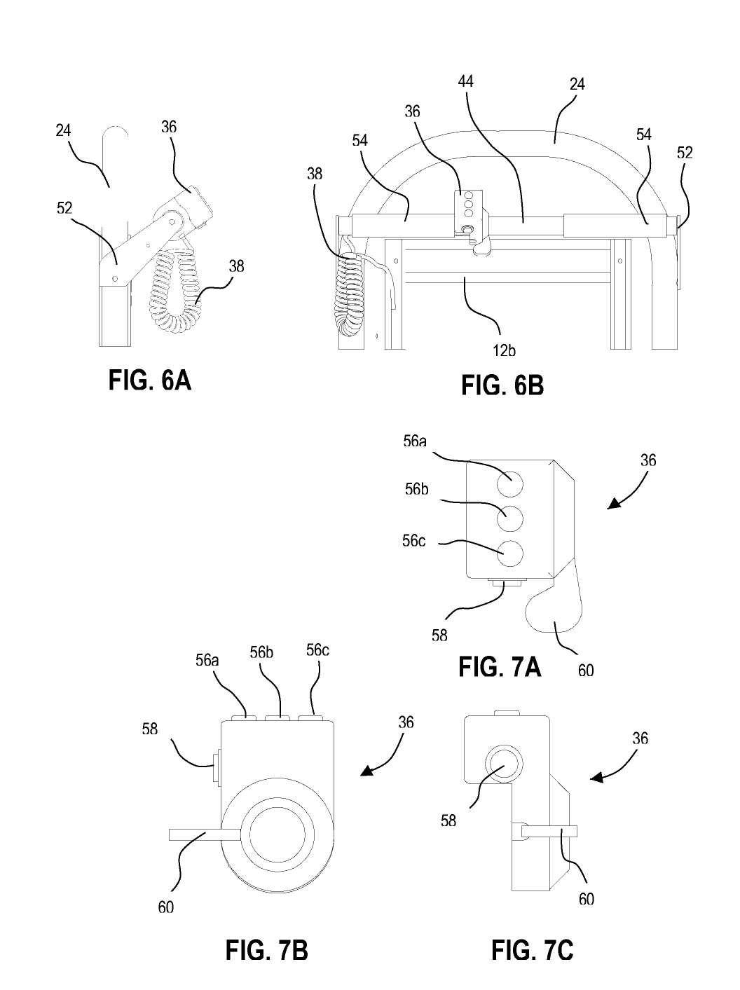

The speed control components can be seen specifically in side view FIG. 6A and in front view FIG. 6B as attached to convertible frame 24 and as seen with second frame 12b when the power-assist hand truck 18 is in two-wheel mode, and additionally as part of the power-assist hand truck 18 in FIGS. 4A, 4B, and 5. The speed control assembly consists of the speed control handle 44 attached to the convertible frame 24 by two speed control handle brackets 52, a grip mountable speed control 36 attached to speed control handle 44 and set in horizontal and rotational place by means of a mechanical setscrew engaged on the speed control handle 44, two identical speed control handle grips 54, and a speed control cable 38.

Speed control handle 44 is an aluminum tube preferably one-half inch to one and one-half inches in diameter and more preferably seven-eighths inch in diameter extending approximately sixteen and one-half inches in length. The diameter, material, curvature, design, and length of speed control handle 44 can be varied. Additionally, the speed control handle 44 may be omitted entirely if the speed control 36 is directly or indirectly mounted to an alternate handle or frame. The speed control handle 44, speed control brackets 52, speed control cable 38, and speed control handle grips 54 may be omitted entirely if the speed control 36 is made to be wireless.

Speed control handle brackets 52 whereby said brackets have a left and right hand version are formed specifically to attach to and be mechanically supported by the contour of convertible frame 24 and additionally preferably by bolts utilizing existing mounting holes in convertible frame 24. The speed control handle brackets 52 are attached to the speed control handle 44 by means of a machine screw placed through a hole in the bracket and secured into a threaded insert attached internally in each end of the speed control handle 44 tube. The speed control handle brackets 52 are made of formed aluminum sheet metal but could also be made of various materials including but not limited to plastic, steel, aluminum alloys, or a combination thereof. Speed control handle brackets 52 could be mounted in locations other than shown, could consist of a singular unit rather then two units, could be symmetrically designed to avoid the need for right and left hand versions, and could be designed for and mechanically secured by methods including friction, riveting, and bolting. The speed control handle grips 54 are preferably one to two inches in diameter and more preferably one and one-eighth inches in diameter and five to eight inches in length. The speed control handle grips 54 are preferably made of durable rubber, vinyl, or foam rubber tubing. The internal diameter of the speed control handle grips 54 is preferably such that friction between the internal surface and the outer diameter of the speed control handle 44 hold the grips in place. The speed control handle grips 54 could be made of various materials and could be secured using other methods including setscrews or they may be omitted entirely if desired.

The speed control cable 38 is connected to the bottom of speed control 36 routed under the speed control handle grip 54 inside speed control handle 44 exiting orthogonally at its end, coiling, running against and parallel to second frame 12b in the direction of the controller 48, and finally exiting the second frame 12b perpendicularly and entering into the controller 48. In FIGS. 4A and 4B the speed control cable 38 can be seen with excess cable coiled to the side of and immediately below the speed control handle 44. When converted to platform mode as in FIG. 5 the speed control cable 38 stretches and extends parallel to convertible frame 24. The routing of speed control cable 38 may vary, the speed control cable 38 may or may not include coils, may be divided into multiple cables, and may include electrical contactors along its path.

The speed control 36 is shown in top view in FIG. 7A, in side view in FIG. 7B, and in end view in FIG. 7C. Battery indicator lights are located on the top of the speed control 36, which includes a full battery light 56a, a partial battery indicator 56b, and a low/dead battery indicator light 56c. Alternatively, the battery level indicator may take many forms including that of a digital readout. A push-button e-stop switch 58 is located on the end of the speed control 36 and is positioned as to be easily accessible to the operators thumb, but may also be located elsewhere on the power-assist hand truck 18. Engaging the e-stop switch 36 severs electrical power to the gearmotors 40, whereas disengaging the e-stop switch 36 re-connects electrical power to the gearmotors 40. As such, the speed control 36 thumb throttle 60 has no effect when the e-stop switch 36 is engaged. The e-stop switch 58 may work in various ways in order to have the primary effect as to stop the operation of the power-assist hand truck 18 and to additionally effect the un-powered resistance of the power-assist hand truck 18 to rolling either forward or reverse (toward the operator). In the present invention embodiment the gearmotors 40 provide very little rolling resistance to reverse motion of the power-assist hand truck 18 when the e-stop switch 58 is engaged. Alternatively, when the e-stop switch 58 is disengaged the regenerative braking of the gearmotors greatly increases the reverse rolling resistance and thereby reduces and limits the power-assist hand truck 18 reverse speed. The thumb throttle 60 is mounted to the end of the speed control 36 in such position as to be easily accessible by either the operators left or right hand thumb. The speed control 36 is infinitely variable by depressing the thumb lever 60 and through the controller 48 controls the output torque and thereby the speed of the power-assist hand truck 18 preferably between the speeds of 0 mph and 8 mph, more preferably between 0 mph and 6 mph, and most preferably between 0 mph and 4 mph. Additionally, the controller 48 may be programmed to maintain a given speed, control acceleration, control deceleration, and/or provide independent speed ranges for the 2-wheel mode and the platform mode. The variable thumb throttle 60 may also be replaced by an automatic throttle control utilizing sensory technologies including, but not limited to the ability to sense speed and directional intent of the operator and automatic adjustments in speed and direction to aid in balancing of the load.

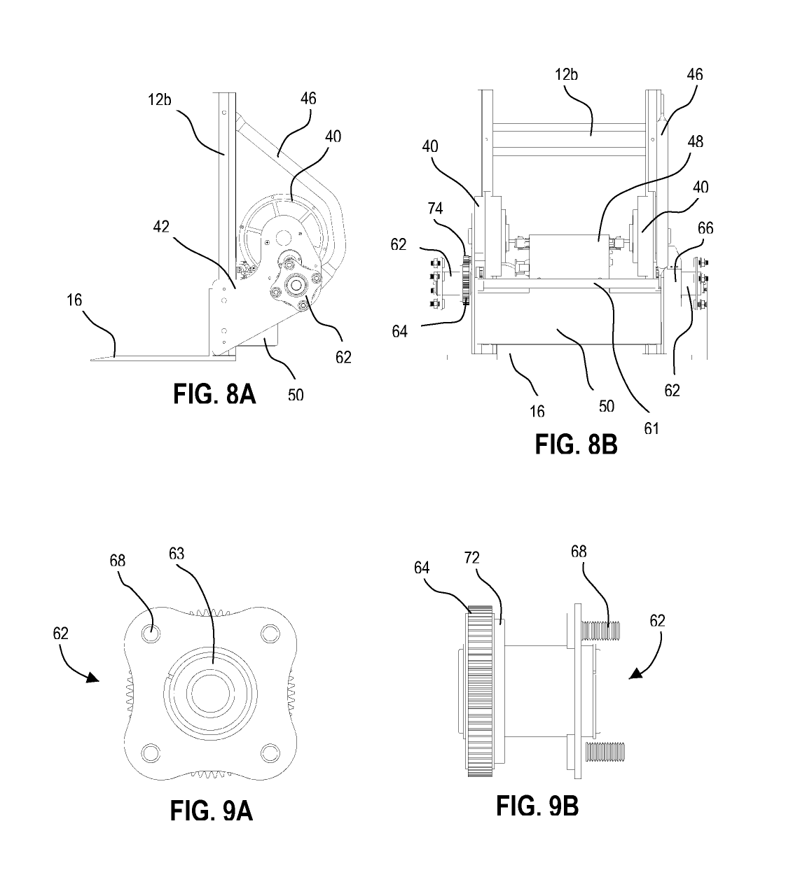

The lower third of the power-assist hand truck 18 as seen in side view FIG. 8A and front view FIG. 8B wherein the wheels 14, left skid rail 46, and left grease cover 66 are not shown in order to provide an unobstructed view of the overrunning clutch hub 62, secondary gear 64, secondary input gear 74, and right grease cover 66.

The skid rails 46 are preferably constructed of steel tubing and bolted to the side plates 42 on the lower end and bolted to the second frame 12b on the upper end. Skid rails 46 may be constructed of aluminum, steel, plastic, or a combination of various materials. The skid rails 46 may vary in design and mounting preferably while acting as barriers to damage of the power-assist components and additionally as aids to movement over obstacles. Preferably the side plates 42 may be so designed to act as skid rails 46 in addition to their other functions.

The overrunning clutch hub 62 can be seen in side view with respect to the power-assist hand truck 18 in FIG. 9A and front view with respect to the power-assist hand truck 18 in FIG. 9B. The overrunning clutch hub 62 consists of four wheel mounting studs 68 which protrude through and bolt to the wheels 14, a secondary gear 64 which is mated to and powered by the secondary input gear 74, bearings 63 which are mounted to the axle 61, and an overrunning clutch 72 which allows for free rotation of the wheels 14 in forward motion during all modes of power-assist hand truck 18 operation. Thus, an operator may move the power-assist hand truck 18 faster than the motor-assist can independently move the load without encountering resistance due to the motors and transmission.

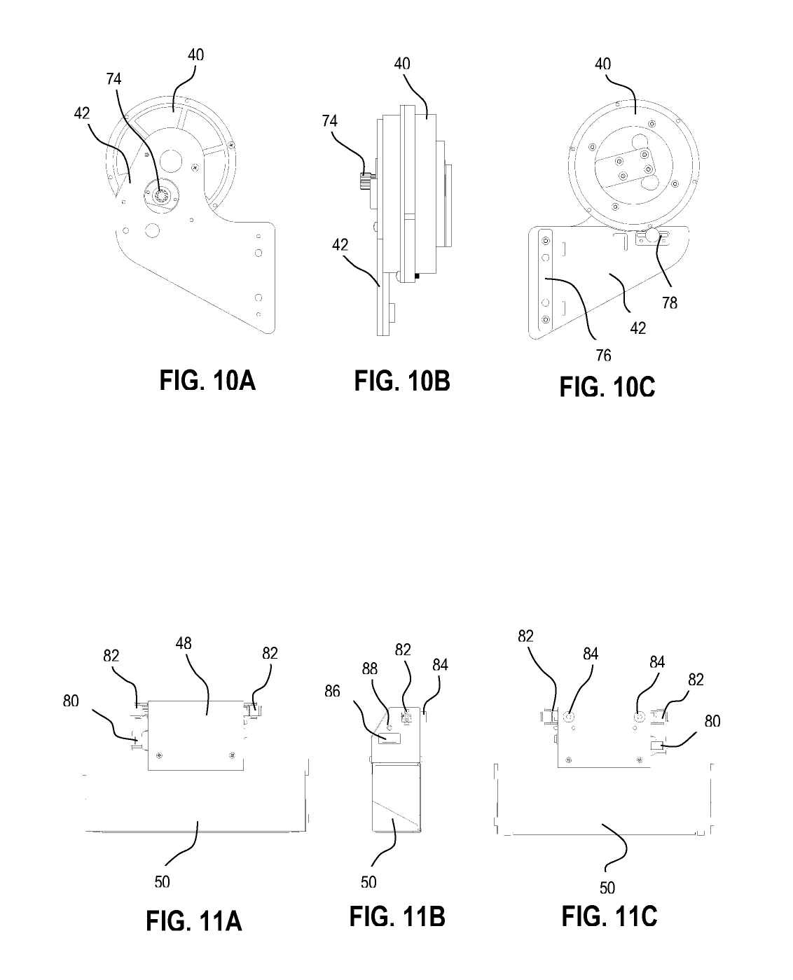

Side plate 42 can be seen from wheel side (outside) view in FIG. 10A, end view in FIG. 10B, and axle side (inside) view in FIG. 10C. The side plate 42 design consists of a thru-hole where secondary input gear 74 protrudes through the plate, mounting holes and a second frame mounting rail 76 which respectively mount and align the side plate 42 to the second frame 12b, and an axle pin rotary lock 78 which encapsulates a spring pin located through axle 61 and prevents axle 61 from rotating during operation.

The controller 48 and batteries 50 can be seen in the front view of FIG. 11A, side view of FIG. 11B, and back view of FIG. 11C. The batteries 50 are preferably twelve volt, twenty four volt, or thirty six volt and preferably replaceable and/or rechargeable batteries, and more preferably two twelve volt batteries in series providing a total of twenty four volts and 10 amp-hrs, and most preferably are approximately two and one-half inches wide by three and one-half inches tall by six inches long. The batteries 50 may be lead acid, lithium, nickel metal hydride, nickel cadmium, or lithium iron phosphate, most preferably lithium iron phosphate batteries. The controller 48 can switch connection of the batteries 50 from twenty-four volt series used to power the gearmotors 40 to twelve volt parallel allowing direct charging from 12V sources such as automotive electrical systems. Battery connectors are preferably quickly connected and disconnected using spring connectors or quick disconnect plugs. Charging contacts 84 can be seen in FIG. 11B and FIG. 11C. The contacts are connected to controller 48. To re-charge the batteries 50 the charging contacts 84 should be connected to an external power source.

The speed control cable plug 80 and gearmotor cable plugs 82 as seen in FIGS. 11A, 11B, and 11C are preferably weather resistant and more preferably weatherproof. The plugs may be located nearer the gearmotors 40 and speed control 36 or may be located nearer the control circuitry inside the controller 48.

The power-assist hand truck 18 power switch 86 can be seen in FIG. 11B. The power switch 86 connects and disconnects the controller 48 from the batteries 50, thus turning the power-assist hand truck 18 on and off. The power switch 86 is preferably located in a visible and easily accessible area. The status indicator light 88 can be seen in FIG. 11B. The status indicator light 88 is governed by the controller 48 and displays diagnostic information and current mode of operation information by turning on, off, or blinking at given intervals. Preferably the status indicator light 88 is placed in a highly visible location with respect to the operator and provides confirmation of charging mode, on, off, and system faults.

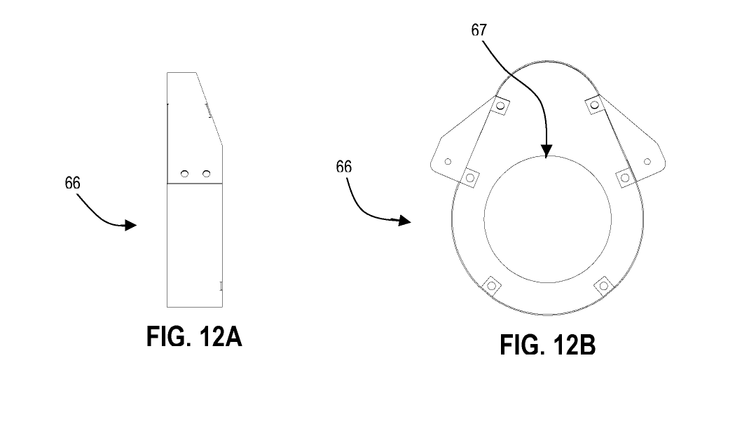

The grease cover 66 can be seen in front view in FIG. 12A and in side view in FIG. 12B. The grease cover preferably encapsulates the second gear 64 and second input gear 74 thereby protecting the gear set from the environment and containing the grease. The grease cover hub thru-hole 67 preferably provides a close fit around the overrunning clutch hub 62. The grease cover 66 is made preferably from sheet metal and more preferably from molded plastic.

### ADVANTAGES

From the description above, a number of advantages of some embodiments of our Power-assist Hand Truck or Platform Cart become evident.

The fully assembled power-assist hand truck weighs less than 70 lbs, almost one-third to one-half the weight of the prior art powered hand trucks, thus providing several advantages. Delivery drivers can safely lift the power-assist hand truck onto and off of their delivery trucks without the use of time consuming lifts or ramps. Additionally, this makes it easier for any operator to maneuver the power-assist hand truck, including during power-assist failure.

The maximum speed of the power-assist hand truck is not limited by the drive components. The overrunning clutches allow the operator to walk as quickly as they desire without resistance from the drive components.

A convenient pushbutton on the speed control handle allows the operator to engage and disengage the resistance of the drive components very quickly.

An exposed axle is available so the operator can use the power-assist hand truck in similar fashion to a common manual hand truck. They can rest their foot against the axle to initiate balancing the load in two-wheel mode.

### CONCLUSIONS, RAMIFICATIONS, AND SCOPE

Thus the reader will see that at least one embodiment of the Power-Assist Hand Truck or Platform Cart provides a lightweight and user-friendly device that will help an operator reduce exertion on their body while maintaining a productive work pace.

While the above description contains many specificities, these should not be construed as limitations on the scope of any embodiment, but as exemplifications of various embodiments thereof. Many variations and ramifications are possible within the teachings of the various embodiments. For example, the convertible hand truck embodiment may take the form of a platform cart, which is not convertible, but permanently confined to a platform state and may be substantially larger than a hand truck.

Thus the scope should be determined by the appended claims and their legal equivalents, and not by the examples given.

I claim:

1. A powering assembly for converting a manual hand truck to a power-assist hand truck, the assembly comprising:
a first and second electric motor;
a transmission means for driving one wheel of the hand truck using the first electric motor and for driving a second wheel of the hand truck using the second electric motor;
a motor controller electrically connected to the motors;
a speed control electrically connected to the motor controller; and
a power source electrically connected to the motor controller.

2. The powering assembly of claim 1, wherein the hand truck is a convertible hand truck having a two-wheel mode and a platform mode.

3. The powering assembly of claim 1, wherein the outer frame width is between approximately ten inches and approximately eighteen inches.

4. The powering assembly of claim 1, wherein the power source comprises an arrangement of batteries providing between approximately twelve volts and approximately thirty six volts.

5. The powering assembly of claim 1, wherein each motor is between approximately one eighth continuous horsepower and approximately one half continuous horsepower.

6. The powering assembly of claim 1, wherein the total weight of the assembly is between approximately 10 lbs and approximately 30 lbs.

7. The powering assembly of claim 1, wherein after assembly on a manual hand truck the hand truck axle remains exposed to the extent that a human foot may rest on or against the axle.

8. The powering assembly of claim 1, wherein at least a portion of the powering assembly resides outside a wheel radius of the wheels, and the powering assembly further including side plates defining a profile for protecting the powering assembly.

9. The powering assembly of claim 1, wherein at least a portion of the powering assembly resides outside a wheel radius of the wheels, and the powering assembly further including side plates defining a profile for acting as skid rails in sliding the hand truck over obstacles.

10. The powering assembly of claim 1, further comprising an overrunning clutch integrated into each transmission means for lowering the rolling resistance of the hand truck in a single direction of travel.

11. The powering assembly of claim 1, further comprising a manually selective switch, which electrically engages and disengages the motors from the power source, facilitating selection between resistive regenerative braking of the hand truck when engaged and lower rolling resistance of the hand truck when disengaged.

12. The powering assembly of claim 1, wherein the transmission means is comprised of a plurality of gears.

13. The powering assembly of claim 1, wherein the power source can be charged via direct electrical connection to an automotive electrical system.

14. The powering assembly of claim 1, wherein the power source can be charged via a battery charger.

15. A power-assist hand truck comprising:
a hand truck having a frame defining an outer frame width;
a handle connected to the frame for guiding the hand truck;
a first and second electric motor;
right and left wheels supported by an axle;
a transmission means for driving the right wheel of the hand truck using the first electric motor and for driving the left wheel of the hand truck using the second electric motor;
a motor controller electrically connected to the motors;
a speed control electrically connected to the motor controller; and
a power source electrically connected to the motor controller.

16. A power-assist platform cart comprising:
a frame defining an outer frame width for supporting a load on a horizontal plane, said frame having a front end and rear end;
a handle for guiding the platform cart attached upright and perpendicular to the frame at the front end;
a first and second electric motor;
right and left wheels supported by an axle;
a transmission means for driving the right wheel of the platform cart using the first electric motor and for driving the left wheel of the platform cart using the second electric motor;
a motor controller electrically connected to the motors;
a speed control electrically connected to the motor controller; and
a power source electrically connected to the motor controller.

17. The power-assist platform cart of claim 16, further comprising a second upright attached perpendicular to the platform at the rear end.

18. The powering assembly of claim 16, wherein the outer frame width is between approximately ten inches and approximately thirty six inches.
